(19) United States
(12) Patent Application Publication
(10) Pub. No.: US 2011/0018465 A1
(43) Pub. Date: Jan. 27, 2011

(54) METHOD AND APPARATUS FOR LIGHT INTENSITY CONTROL

(75) Inventor: Ian Ashdown, West Vancouver (CA)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/863,086

(22) PCT Filed: Dec. 2, 2008
(86) PCT No.: PCT/IB2008/055038

§ 371 Date: Oct. 4, 2010

Related U.S. Application Data
(60) Provisional application No. 61/021,712, filed on Jan. 17, 2008.

(51) Int. Cl. H05B 37/02

(52) U.S. Cl. 315/294

(57) ABSTRACT

The present invention provides a method and apparatus for optical feedback control for a lighting unit (10), wherein the control signal for an array of one or more light sources (20) is configured using a CDMA modification signal. Signals provided by an optical sensor (60) at least detecting the light emitted by the array of one or more light sources, can be filtered based on the CDMA modification signal, thereby enabling discrimination of the portion of the signals from the optical sensor (60) which are reflective of optical characteristics of the light emitted by the array of one or more light sources (20). In embodiments of the present invention, the determined optical characteristics can be used for example for feedback control of an illumination system.

### TECHNICAL FIELD

The present invention is directed generally to illumination systems. More particularly, various inventive methods and apparatus disclosed herein relate to a light intensity control method and apparatus for illumination systems.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

It is well known that light of a desired spectral composition or, in photometric terms, a desired chromaticity and luminous flux, can be generated by intermixing adequate amounts of light from different color light sources. When light from, for example, different color LEDs is intermixed, the chromaticity of the mixed light can be sufficiently accurately determined by characteristics such as the intensities, center wavelengths and spectral bandwidths of the LEDs.

The characteristics of LEDs can vary for a number of reasons, for example, device aging and/or fluctuations in device operating temperature. These variations can cause undesirable effects under operating conditions of the LEDs. Possible solutions include optical feedback control to monitor the luminous flux output of the different color LEDs and to adjust the drive currents of the LEDs such that the luminous flux output and chromaticity of the light emitted by each LED or at least the mixed light generated by a group of LEDs remains substantially constant. Monitoring the emitted light requires some means of measuring the luminous flux output per LED color or per LED, for example.

To date, several optical feedback solutions have been proposed to detect and evaluate the luminous flux output and chromaticity of the output light of a lighting device in order to monitor these characteristics. For instance, one solution teaches an array of photosensors each having a selected color filter responsive to light of a selected color. Such photosensors however, are typically prone to optical crosstalk due to the overlap in the spectral radiant power distribution of the light emitted by various colors of LEDs. This optical crosstalk can reduce the accuracy of the light information collected by the photosensors. In addition, this approach is susceptible to the presence of ambient light; for example ambient light in the color range of each optical filter may not be distinguishable from output light of the lighting device.

Another solution includes a LED lighting fixture with multi-channel color sensors for optical feedback, wherein each channel is comprised of a broadband photosensor and a color filter with transmittances that approximate that of the red, green and blue LED spectral radiant power distributions. Since the spectral radiant power distributions of the LEDs tend to overlap for the different colors, channel crosstalk is inevitable and can limit the performance of the optical feedback system. In addition, this approach is also susceptible to ambient light.

A similar solution includes a multiplicity of photosensors with color filters to isolate the light generated by each LED color. However, this approach again suffers from crosstalk when the spectral power distributions of the LEDs overlap, as occurs for example with red and amber LEDs or warm white and blue or green LEDs. In addition, this approach is also susceptible to ambient light.

A partial solution to the above optical crosstalk problem is to select bandpass filters with narrow bandwidths and steep cutoff characteristics. Although satisfactory performance levels for such filters can be achieved using multilayer interference filters, these interference filters can be expensive and typically require further optics for collimating the emitted light, as the interference filter characteristics depend on the incidence angle at which the light impinges on these filters.

Another problem associated with interference filters is that the center wavelength of an LED depends on the LED junction temperature and this center wavelength can vary significantly depending on the type of LED. In addition, the bandpass transmittance spectra of interference filters are also temperature dependent. The output signal of the photosensor therefore depends on the spectral radiant power distribution of the LED as modified by the bandpass characteristics of the interference filter associated therewith. Hence there exist situations where the output signal of the photosensor may change with ambient temperature even if the LED spectral radiant power distribution remains constant, which can further limit the performance of the sensor system.

In yet another approach, radiation from each LED color can be controlled by an electronic control circuit, which selectively turns off the LEDs corresponding to colors not currently being measured in a sequence of time pulses. A single broadband optical sensor can then be used for detection. A problem with this approach is that color balance is periodically and potentially drastically altered each time the LEDs are de-energized, thereby possibly causing noticeable flicker. Since the optical sensor requires a minimum amount of time to sense the radiant flux of the energized LEDs accurately and with an acceptable signal-to-noise ratio, the choice of sampling frequencies can be limited by the sensitivity and noise characteristics of the optical sensor. A limited sampling frequency can result in lower sampling resolution and longer response times for the optical feedback loop. Since light from no more than one LED color is measured at a time, this approach for optical data collection can increase the feedback loop response time by about the number of different LED colors used in the system. For example, for a system with red, green, and blue LED clusters the response time can be multiplied by factor of about three, and for a system with red, green, blue, and amber LED clusters the response time can be multiplied by a factor of about four. In addition, this approach is also susceptible to ambient light, which cannot be selectively prevented from reaching the optical sensor.

One possible approach to avoid visual flicker is to switch the LEDs ON and OFF using a very fast pulse sequence. However, this approach is consequently susceptible to drive current ripple, electrical noise, and the rise and fall times of the LED drive current pulses.

Another possible approach to avoiding visual flicker is to ensure the average light output during a period where light sources are pulsed is substantially equal to the nominal continuous light output during the ordinary operation. Another approach is to alleviate the flicker by turning off the LEDs for the color currently being measured, instead of turning off the other LEDs, then calculating the desired measurement by subtraction. Neither of these proposed solutions, however, addresses periodic and potentially drastic changes in color balance or degradation in feedback loop response time due to the deactivation sequences required for light sampling.

The sequential pulsing solution is also susceptible to interference from adjacent LED clusters unless the pulse sequence is precisely synchronized between LED clusters, which may for example be in different lighting fixtures. Even then, if the LED clusters are generating different amounts of colored light, the output of one cluster may be inadvertently sensed by another cluster.

In another approach, LEDs are driven by PWM drive current pulses, and the light output of the LEDs is sampled by a broadband optical sensor whenever the drive current has reached full magnitude. This procedure can avoid the effect of the rise and fall times of the PWM pulse. The average drive current can then be determined by low pass filtering. A difficulty associated with this approach can be that the PWM pulses must be synchronized such that at least one LED color is de-energized for a finite period of time during the PWM period. This requirement can prevent operation of all different color LEDs at full power at 100% duty factor. Another disadvantage associated with the average light sensing method is that the sampling period typically must provide sufficient time for the optical sensor to reliably measure the radiant flux of the energized LEDs. In addition this light sensing method requires that the LED colors are to be measured sequentially, which can limit the feedback loop response time.

LEDs of different colors can also be driven with different drive waveforms having different frequencies, thereby allowing the intensity of each LED color to be measured using a lock-in amplifier (homodyne) technique. While this approach is insensitive to ambient light, it is susceptible to interference from adjacent LED clusters unless each cluster is assigned a unique set of modulation frequencies. While digital frequency synthesis techniques are known, they are not generally suitable for microcontrollers in products requiring high volume production and low cost. Requiring different frequencies for each LED clusters would also complicate installation and commissioning of lighting fixtures utilizing the LED clusters.

Thus, there is a need in the art for a new method and apparatus for light intensity control for a lighting fixture.

### SUMMARY

The present disclosure is directed to inventive methods and apparatus for light intensity control in illumination systems. In various embodiments and implementations of the invention, a control signal used for driving an array of one or more light sources is configured using a Code Division Multiple Access (CDMA) modification signal. Different control signals can be configured using different CDMA modification signals, so that light from different arrays is configured differently. The CDMA modification signals can be used to facilitate discrimination of optical characteristics for each array when light from the arrays is mixed. To this end, the mixed light can be electronically filtered according to a CDMA modification signal to recover aspects of the light configured using that CDMA modification signal. The output of an electronic filter can thus be substantially proportional to the radiant flux output of the associated array. The controller can use this information as feedback to adjust the control signals. In embodiments of the present invention, the determined optical characteristics can be used for example for feedback control of an illumination system.

Generally, in one aspect, there is provided a lighting unit (10) for generating light having a desired luminous flux and/or chromaticity, the lighting unit comprising: one or more first arrays (20) of one or more light sources adapted to generate first light in response to a first drive current and one or more second arrays (30) of one or more light sources adapted to generate second light in response to a second drive current; a first current driver (28) configured to supply the first drive current to the one or more first arrays based on a first control signal, and a second current driver (38) configured to supply the second drive current to the one or more second arrays based on a second control signal; an optical sensor (60) for sensing a portion of the light comprising a combination of the first light and second light, the optical sensor configured to generate a sensor signal representative of the light; a controller (50) configured to generate the first control signal and second control signal based at least in part on the desired luminous flux and/or chromaticity, the first control signal configured at least in part according to a first CDMA modification signal, thereby resulting in the first light being modulated at least in part according to the first CDMA modification signal; and an electronic CDMA filter (24) configured to electronically filter the sensor signal based on the first CDMA modification signal, thereby determining one or more optical characteristics of the first light for feedback to the controller; thereby providing feedback to the controller to facilitate generating light having a desired luminous flux and/or chromaticity.

In another aspect, there is provided a method for generating light having a desired luminous flux and/or chromaticity, the light comprising first light from a first light source and second light from a second light source, the method comprising the steps of: generating a first drive current and a second drive current, each based at least in part on the desired luminous flux and/or chromaticity, the first drive current further configured at least in part according to a first CDMA modification signal; driving the first light source and the second light source according to the first drive current and the second drive current, respectively, thereby resulting in the first light being modulated at least in part according to the first CDMA modification signal; generating a sensor signal representative of the light; and filtering the sensor signal based on the first CDMA modification signal, thereby determining one or more optical characteristics of the first light for feedback when generating a new first drive current and a new second drive current.

In another aspect, there is provided a computer program product comprising a computer readable medium having recorded thereon statements and instructions for execution by a processor to carry out a method for generating light having a desired luminous flux and/or chromaticity, the light comprising first light from a first light source and second light a second light source, the method comprising the steps of: generating a first drive current and a second drive current, each based at least in part on the desired luminous flux and/or chromaticity, the first drive current further configured at least in part according to a first CDMA modification signal; driving the first light source and the second light source according to the first drive current and the second drive current, respectively, thereby resulting in the first light being modulated at least in part according to the first CDMA modification signal; generating a sensor signal representative of the light; and filtering the sensor signal based on the first CDMA modification signal, thereby determining one or more optical characteristics of the first light for feedback when generating a new first drive current and a new second drive current.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dice which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dice that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of luminous power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a full-width-half-maximum (FWHM) bandwidth having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K. Lower color temperatures generally indicate white light having a more significant red component or a “warmer feel,” while higher color temperatures generally indicate white light having a more significant blue component or a “cooler feel.”

The term “lighting fixture” is used herein to refer to an implementation or arrangement of one or, more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media. In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) one or more other devices connected to the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

The term “optical sensor” is used to define an optical device having a measurable sensor parameter in response to a characteristic of incident light, such as its luminous flux or radiant flux. The term “broadband optical sensor” is used to define an optical sensor that is responsive to light within a wide range of wavelengths, such as the visible spectrum for example. The term “narrowband optical sensor” is used to define an optical sensor that is responsive to light within a narrow range of wavelengths, such as the red region of the visible spectrum for example.

The term “chromaticity” is used to define the perceived color impression of light according to standards of the Illuminating Engineering Society of North America. The term “luminous flux” is used to define the instantaneous quantity of visible light emitted by a light source according to standards of the Illuminating Engineering Society of North America. The term “spectral radiant flux” is used to define the instantaneous quantity of electromagnetic power emitted by a light source at a specified wavelength according to standards of the Illuminating Engineering Society of North America. The term “spectral radiant power distribution” is used to define the distribution of spectral radiant flux emitted by a light source over a range of wavelengths, such as the visible spectrum for example. The term “radiant flux” is used to define the sum of spectral radiant flux emitted by a light source over a specified range of wavelengths.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a block diagram of an illumination system according to an embodiment of the present invention.

FIG. 2 schematically illustrates a setup of two luminaries according to an embodiment of the present invention.

FIG. 3 illustrates an example of four waveforms representing orthogonal CDMA modification codes according to an embodiment of the present invention.

FIG. 4 illustrates an example of binary data encoding using CDMA according to an embodiment of the present invention.

FIG. 5 illustrates signal diagrams with superimposed pulse width modulation (PWM) drive current signals and frequency filtered drive current signals according to an embodiment of the present invention.

FIG. 6 illustrates a block diagram of an illumination system according to an embodiment of the present invention.

FIG. 7 illustrates an example comparison of CDMA transmission according to an embodiment of the present invention versus sequential transmission of data.

### DETAILED DESCRIPTION

Measuring aspects of different light sources contributing to mixed light in an illumination system can be useful for feedback and control purposes. However, conventional approaches to the problem of discriminating light from component light sources are often complex or, in some cases, inadequate. The solution proposed herein involves controlling each light source using a CDMA modification signal, which provides for discrimination of characteristics of light from each light source contributing to the mixed light. For this purpose, an optical sensor and CDMA filters configured based on the CDMA modification signals for each light source can be used. The COMA filters can be configured to discriminate light from substantially one light source by providing the CDMA filter with the same CDMA modification code or signal that is used for controlling the corresponding light source.

More generally, Applicants have recognized and appreciated that it would be beneficial to use spread spectrum and/or multiple access communication techniques to configure light from different light sources, such that discrimination of characteristics of lighting components in a mixed light scenario is possible via time-based or sequence-based filtering.

In view of the foregoing, various embodiments and implementations of the present invention are directed to methods and apparatus for an optical feedback control system of a lighting unit, wherein the control signal for each array of one or more light sources corresponding to a particular color is independently configured using a CDMA modification signal which is different for each color. Electronic CDMA filters which are configured to respond to these CDMA modification signals to recover information about the radiant flux of the light source, are used to discriminate between the radiant flux corresponding to each of the different colors of light sources from the sample of the mixed radiant flux output collected by, for example one or more broadband optical sensors. The output of an individual electronic CDMA filter can be substantially directly proportional to the radiant flux or peak radiant flux output of the light sources of the associated color. This information can subsequently be used by the controller together with the desired luminous flux and chromaticity of the output light, in order to generate subsequent control signals for different light source arrays of the lighting unit.

In various embodiments of the present invention, since the CDMA modification signal for each color is substantially independent of its spectral radiant power distribution, a filter's output signal is substantially unaffected by the spectral power distribution overlap of the radiant flux emitted by different color light sources.

An illumination system according to many embodiments of the invention is formed from a plurality of lighting units. Each array of light sources in a particular lighting unit is independently configured using a CDMA modification signal which is different for each array of light sources and each lighting unit whenever the potential for interference between lighting units exists. Electronic CDMA filters are configured to respond to these CDMA modification signals to recover information about the radiant flux of one or more light sources and thereby discriminate between the radiant flux corresponding to each of the different colors of light sources of each lighting unit from the sample of the mixed radiant flux output collected by a broadband optical sensor. The output of an individual CDMA filter can be substantially directly proportional to the radiant flux output of the light sources of the associated color and lighting unit. This information can subsequently be used by the control system in each lighting unit together with the desired luminous flux and chromaticity of the emitted light from that lighting unit, in order to generate subsequent control signals for each color of light source array via optical feedback.

In one embodiment of the present invention, an adequate sensor and signal processing system for sensing light and for processing the sensed signal can comprise a broadband optical sensor and a predetermined number of electronic CDMA filters for determining the modulated intensities and average continuous intensities for the light emitted by the different colors of light sources. The optical sensor and signal processing system can comprise a type of passive or active analog or digital, discrete-time (sampled) or continuous-time, linear or non-linear, infinite impulse response (IIR type) or finite impulse response (FIR type) analog, digital subsystem, or the like as would be readily understood by a person skilled in the art. In one embodiment of the present invention, electronically filtering of the optical signal from the optical sensor can be performed using one or a combination of analog circuitry filtering and digital filtering.

The drive current of the light source can be adjusted using a CDMA modification signal. For example, the CDMA modification signal can be superimposed on other sources of drive current at all times or during prespecified time intervals, or the CDMA modification signal can be interleaved with other sources of drive current. Said other sources of drive current may be, for example, drive current intended to control the intensity of light of the light source for illumination purposes. The waveform of the CDMA modification signal for each color and optionally each lighting unit can be chosen to avoid undesired illumination effects. The CDMA modification signal can be applied to the drive current continuously or intermittently. In one embodiment, in order to improve signal to noise ratios, intermittent application of the CDMA modification signal in short bursts can allow the CDMA modification signal to have high amplitudes without undesired effects such as noticeable flicker, whereas low amplitudes can allow modulations for longer periods or continuous modulation.

When adequately modulating the light source drive currents, radiant flux output measurements can be performed without necessarily sequentially selectively turning ON or OFF different color light sources. Accordingly, deviations in the radiant flux outputs of for example the red light sources, green light sources, and blue light sources from the desired luminous flux and chromaticity, can be detected and compensated for by the controller. The measured radiant flux of the different color light sources is substantially independent of practically relevant shifts in the center wavelengths of the light sources. Thus, while changes in light source junction temperatures may change the ratio of drive current to radiant flux output, typically consequent changes in light source center wavelength emission do not impact the measurements of the radiant flux output of the different color light sources.

In one embodiment of the present invention, a lighting unit can be configured such that under operating conditions the one or more sensors receive light that practically only originates from the lighting unit. Alternatively the lighting unit can be configured such that under operating conditions its sensor(s) can also receive practically relevant amounts of ambient light such as light from other lighting units such as from a nearby second lighting unit, for example. The lighting unit can also be configured such that its sensors practically primarily receive a portion of the light that it provides to illuminate objects and which is reflected back to the sensor(s). This can be used, for example, to control a multi-color light source based lighting unit that is configured to mix differently colored light and provide a desired illumination pattern only at predetermined distances from the lighting unit.

In many embodiments of the present invention, one or more lighting units comprise an array of one or more similar light sources. In this configuration, the light sources can be of nominally the same monochromatic wavelength or the light sources could be white light LEDs containing photo-luminescent material such as certain phosphor materials, for example. The average intensities of each lighting unit can be maintained substantially constant despite changes in ambient temperature and/or possible light interference from other lighting units. The present invention can similarly be applied to a hierarchical arrangement of sub-arrays of light sources.

Lighting Unit with Optical Feedback Apparatus

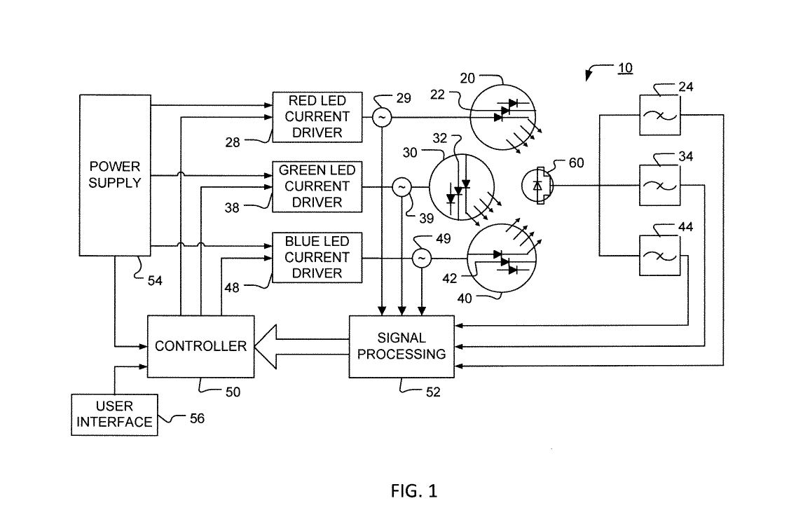

FIG. 1 illustrates a block diagram of a lighting unit 10 according to one embodiment of the present invention. As illustrated, the lighting unit 10 includes arrays 20, 30 and 40 each array having one or more light sources 22, 32 and 42. In this embodiment the light sources 22, 32 and 42 can generate radiation in the red, green, and blue regions of the visible spectrum. Alternative embodiments of the present invention can have different numbers of nominal light source colors or additionally include light sources of other colors such as amber, pink or white etc. The light sources 22, 32 and 42 can be thermally connected to a common heat sink or alternatively to separate heat sinks (not shown) for improved thermal management of certain operating conditions of the light sources 22, 32 and 42. Embodiments of the lighting unit can include mixing optics (not shown) for intermixing the light emitted by the different color light sources. It is noted that when differently colored light sources emit light which is adequately mixed, controlling color and intensity of the mixed light is then a matter of controlling the amount of light provided by each of the same color light sources. The color of the mixed light can thus be controlled within a range of colors defined by the color gamut of the lighting unit, wherein the color gamut is defined by the different color light sources within the lighting unit subject to achievable operating conditions.

With continuing reference to FIG. 1, current drivers 28, 38 and 48 are coupled to arrays 20, 30 and 40, respectively, and are configured to separately supply current to the red light sources 22, green light sources 32, and blue light sources 42 in arrays 20, 30 and 40. A power supply 54 coupled to the current drivers 28, 38 and 48 can provide electrical power. The current drivers 28, 38 and 48 control the amount of drive current supplied to and hence the amount of light emitted by light sources 22, 32 and 42. The current drivers 28, 38 and 48 are configured to regulate the supply of current to each array 20, 30 and 40 separately so as to control the luminous flux and chromaticity of the combined mixed light.

In one embodiment, the current drivers 28, 38 and 48 provide a pulsed drive current, for example a pulse width modulated (PWM), pulse code modulated (PCM), or pseudorandom pulse code modulated drive current for controlling the luminous flux and chromaticity of the combined emitted light of the red light sources 22, green light sources 32, and blue light sources 42. For PWM controlled light sources the average drive current through light sources 22, 32 or 42 is proportional to the duty factor of a PWM control signal. Therefore it is possible to control the amount of light generated by light sources 22, 32 or 42 by adjusting the duty factor for each array 20, 30 and 40, respectively. The dimming of the red light sources 22, green light sources 32, or blue light sources 42 affects the mixed radiant flux output of the lighting unit. The current drivers can be current regulators, switches or other similar devices as would be known to those skilled in the art. Alternate control techniques for controlling the activation of the light sources would be readily understood by a worker skilled in the art.

Those having skill in the art will readily recognize that, in embodiments of the present invention, the PWM, PCM, or pseudorandom PCM control signals generated by the controller can be implemented as computer software or firmware on a computer readable medium having instructions for determining the PWM, PCM, or pseudorandom PCM control signal sequence.

In one embodiment, the current drivers 28, 38 and 48 provide an amplitude modulated drive current for controlling the luminous flux and chromaticity of the combined emitted light of the red light sources 22, green light sources 32, and blue light sources 42. For amplitude modulated systems, it is possible to control the amount of light generated by light sources 22, 32 or 42 by adjusting the amount of current provided to each array 20, 30 and 40, respectively. The amount of light of the red light sources 22, green light sources 32, or blue light sources 42 affects the mixed radiant flux output of the lighting unit. The current drivers can be current regulators, switches or other similar devices as would be known to those skilled in the art. Alternate control techniques for controlling the activation of the light sources would be readily understood by a worker skilled in the art.

Current sensors 29, 39 and 49 can be coupled to the output of current drivers 28, 38 and 48 for continuously sensing the drive current supplied to the arrays 20, 30 and 40. The current sensors 29, 39 and 49 may employ a fixed resistor, a variable resistor, an inductor, a Hall Effect current sensor, or other element which has a known voltage-current relationship and can provide an adequately accurate indication of the drive current.

In some embodiments, the instantaneous forward currents supplied to the arrays 20, 30 and 40 are measured by the current sensors 29, 39 and 49 which can communicate the sensed signals to a signal processing system 52 coupled to the controller 50. The signal processing system 52 can pre-process the drive current signals from the sensors 29, 39 and 49 provide respective information to the controller 50. The signal processing system 52 can include analog-to-digital (A/D) converters, amplifiers, filters, microprocessors, signal processors or other signal processing devices as would be readily understood by a person skilled in the art. According to embodiments of the present invention the functionality of the controller and the signal processing system can be present within a same computing device, or alternately can be provided by separate operatively connected computing devices.

In one embodiment, the output signals from the current sensors 29, 39 and 49 are directly forwarded (not illustrated) to the controller 50 for processing. In one embodiment, the peak forward currents for each array 20, 30 or 40 can be fixed to a pre-set value to avoid measuring the instantaneous forward current supplied to arrays 20, 30 and 40 at a given time.

The controller 50 is coupled to current drivers 28, 38 and 48. The controller 50 is configured to independently adjust each average forward current by separately adjusting the amplitudes, duty cycles, or both amplitudes and duty cycles of each of current drivers 28, 38 and 48. Each of one or more of these signals provided to one or more of the current drivers are each modified using independent CDMA modification signals.

The current drivers 28, 38 and 48 may supply current that is a superposition of a CDMA modification signal and amplitude modulated, PWM, PCM, or pseudorandom PCM drive currents, such as are used to control intensity of light. For example, the CDMA modification signal can result in variations in output light that are on a substantially different time scale than other variations in the output light due to intensity-related drive current control. Electronic filtering can then further include bandpass filtering to isolate fluctuations in light caused by the CDMA modification signal. Alternatively, the CDMA modification signal can be applied in a non-continuous fashion, for example at times when other aspects of the intensity-related drive current control are at a substantially constant predetermined level. Electronic filtering can then further include strobed sampling synchronized with application of the CDMA modification signal in order to recover same. Other methods for superimposing the CDMA modification signal such that it can be adequately discriminated by the electronic CDMA filter as would be understood by a worker skilled in the art.

In one embodiment, the current drivers 28, 38 and 48 supply current that is alternatingly in time a CDMA modification signal and amplitude modulated, PWM, PCM, or pseudorandom PCM drive currents, such as are used to control intensity of light. That is, a CDMA modification signal is interleaved with other drive currents.

In this and other embodiments, each COMA modification signal is generated using a COMA modification code, which is different for each of current drivers 28, 38 and 48. The control signals determine the current generated by the current drivers 28, 38 and 48 which is supplied to red light sources 22, green light sources 32, and blue light sources 42, respectively. Variations of the drive current, which are intended to control the time-averaged amount of light emitted by the light sources, are desirably fast enough to avoid perceivable flicker.

The lighting unit 10 further includes a broadband optical sensor 60 for sensing the emitted light. The output of the optical sensor 60 is coupled to the inputs of electronic CDMA filters 24, 34 and 44. The electronic CDMA filters 24, 34 and 44 can be configured to discriminate, based on the applied CDMA modification signals, between the radiant flux corresponding to each of the different colors of light sources of each lighting unit, from the sample of the mixed radiant flux output collected by a broadband optical sensor. In one embodiment, each of the electronic CDMA filters 24, 34 and 44 is configured for this purpose using the same CDMA modification code used to generate the CDMA modification signals applied at current drivers 28, 38 and 48, respectively.

The electronic CDMA filters can be configurable so that controller 50 can control their responsivity, for example the controller can specify the CDMA modification code used at each sensor to process output from the optical sensor. The optical sensor 60 provides a signal representative of the mixed radiant flux output of the emitted light. The optical sensor 60 can be responsive to the spectral radiant power distributions generated by the red light sources 22, green light sources 32, and blue light sources 42, for example, so as to monitor the contributions of light sources 22, 32 and 42 to the mixed radiant flux output of the lighting unit. The optical sensor can be a phototransistor, a photosensor integrated circuit, an adequately configured LED or a silicon photodiode with an optical filter etc.

In one embodiment of the present invention, the optical sensor is a silicon photodiode with an optical filter that has a substantially constant responsivity to spectral radiant flux within the visible spectrum. An advantage of using an optically filtered silicon photodiode is that this configuration does not require any multilayer interference filters. As a result, this format of optical sensor does not require substantially collimated light. According to embodiments of the present invention, the control signals for activation of the light sources are independently modified by the controller 50 with a CDMA modification signal which is different for different color light sources and can be configured to be different from those used by another lighting unit.

In another embodiment of the present invention, the optical signal representative of the radiant flux incident upon the optical sensor 60 can be electronically pre-processed with amplifier circuitry associated with the optical sensor or it can be processed by analog or digital means in the controller 50.

In one embodiment, a user interface 56 is operatively coupled to the controller 50 to obtain the desired values of luminous flux output and chromaticity of the output light from a user of the lighting unit. Alternately, the lighting unit can have predetermined luminous flux output and chromaticity values of the output light stored in memory associated therewith, for example memory operatively coupled to the controller.

Embodiments of the lighting unit that are suitable for direct illumination applications can be configured differently. In this case the field of view of an optical system may include dynamic or moving objects including persons, for example. Different fractions of the total field of view may be occupied by dynamic objects depending on the size of the field of view. In such situations, the controller of the lighting unit can require a means to separate changes in the sensed reflected light that are caused by the moving objects from changes in the sensed reflected light that are caused by changes in the incident light. Therefore, certain embodiments of the present invention can have a controller which can be calibrated to respond only to slow sensor signal changes, for example as caused by aging of the light sources, and ignore changes on a second or minute timescale.

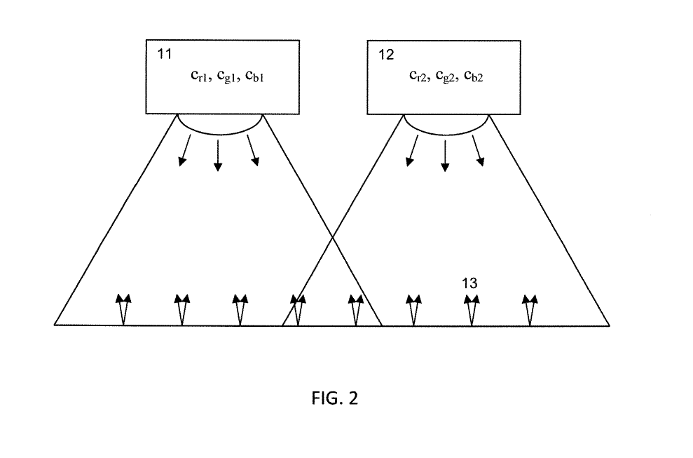

In one embodiment, CDMA modification signals are adequately different for different lighting fixtures. FIG. 2 schematically illustrates an illumination system including lighting fixture 11 and lighting fixture 12 with each including a lighting unit according to an embodiment of the present invention. The light emitted by lighting fixture 11 and lighting fixture 12 may be reflected back from a surface towards the lighting units as indicated by arrows 13, such that light originating from one lighting fixture reaches the sensor(s) of the other lighting fixture or vice versa. This can potentially cause interference with the optical feedback system of the respective lighting fixture. In one embodiment of the present invention the lighting unit associated with lighting fixture 11 uses CDMA modification signals cᵣ₁, c_{g1} and c_{b1}, that adequately differ from the CDMA modification signals cᵣ₂, c_{b2} and c_{g2} used in the lighting unit associated with lighting fixture 12. This enables each lighting unit to discriminate light generated by it from light generated by another lighting unit. For example, if CDMA modification signals cᵣ₁, c_{g1}, c_{b1}, cᵣ₂, c_{g2} and c_{b2} are all generated using substantially mutually orthogonal CDMA modification codes, or are generated using other CDMA modification codes with desirable autocorrelation and cross-correlation properties, then electronic CDMA filters can be configured to adequately discriminate among the different light from lighting fixtures 11 and 12.

### CDMA Modification Signals

In embodiments of the present invention, the control signals or currents driving the light sources are independently modified by the controller with a CDMA modification signal which is adequately different for each color of light source, for example the red light sources, green light sources, and blue light sources, and optionally also adequately different for each lighting unit of an illumination system. For example each of the respective amplitude modulation, PWM, PCM, or pseudorandom PCM control signals or currents for the red light sources, green light sources, and blue light sources, can be modified with different CDMA modification signals for each color.

The CDMA modification signal can be transmitted as a switched binary signal at the beginning or end of each PWM or PCM cycle. In a further embodiment, the amplitude of the CDMA modification signal is the same as the amplitude of the PWM or PCM signal, or in predetermined proportion thereto. In one embodiment, the CDMA modification signal is superimposed or interleaved with other control signals, for example amplitude modulated drive current. The amplitude of the CDMA modification signal may be in predetermined fixed proportion to the amplitude of said other control signals.

In various embodiment of the present invention, the controller determines when and by how much the drive current supplying each light source is modulated. For example, for embodiments with PWM controlled light sources, the drive current may be modulated during every ON-portion of a PWM pulse. Alternatively only certain ON-portions selected according to a predetermined schedule may carry a modulation signal. For example, the proportion of drive current modulated can be configured to achieve an adequate signal-to-noise ratio.

### Selection of CDMA Modification Codes

Adequately different CDMA modification signals can be generated using orthogonal or low cross-correlation CDMA modification codes. In a further embodiment, the CDMA modification codes also have low autocorrelation. Collections of appropriate CDMA modification codes can be generated from a number of types of symbol sequences, for example Walsh-Hadamard sequences, Barker sequences, Katsumi sequences, Gold sequences, Golay sequences, and M-sequences. Typically, such sequences are represented as a list comprising symbols such as 1 and −1. When referring to a CDMA modification code generated using a certain sequence, the sequence name is also used as the code name, for example Gold codes are CDMA modification codes generated using Gold sequences.

In one embodiment, CDMA modification signals are adequately different if they are orthogonal. Orthogonality of CDMA modification signals corresponds to a property of the sequences used to generate them. For example, two signals may be orthogonal if the inner product of their generating sequences is zero. CDMA modification codes generating the CDMA modification signals may similarly be considered orthogonal. In another embodiment, CDMA modification signals may be adequately different even if they are not orthogonal. Non-orthogonal sequences, for example Gold sequences, have autocorrelation and cross-correlation properties that may be useful in generating CDMA modification signals which can be adequately discriminated from a superposition thereof by an electronic CDMA filter. For example, CDMA modification signals can be nearly orthogonal, in the sense that they have low cross-correlation.

Orthogonal CDMA modification codes can be generated using the Walsh-Hadamard method. For example, typically for any integer k greater than or equal to zero, this method may be used to produce a collection of 2^{k} symbol sequences, termed Walsh-Hadamard functions, with each Walsh-Hadamard function being an ordered list or vector of 2^{k} elements, with each element typically represented by either 1 or −1, or more generally by any two numerical values that sum to zero. One property of the Walsh-Hadamard functions so created is that they are mutually orthogonal; for example the vector or inner product multiplication of two Walsh-Hadamard functions yields a result of zero. The number of elements k can be varied according to the number of different CDMA modification codes to be used, along with requirements such as achieving a desired signal-to-noise ratio, or separation between CDMA codes, as would be understood by a worker skilled in the art.

For example, the Walsh-Hadamard method can be used to generate four CDMA modification codes through the recursive series of matrix operations:

$$H ( {2}^{k} ) = [ \begin{matrix}H ( {2}^{k - 1} ) & H ( {2}^{k - 1} ) \\ H ( {2}^{k - 1} ) & - H ( {2}^{k - 1} )\end{matrix} ] , H ( {2}^{0} ) = [ 1 ] \qquad ( 1 )$$

where each column represents an orthogonal symbol sequence. For example as defined by matrix H(4) as follows:

$$H ( 4 ) = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$$

In one embodiment of the present invention, the CDMA modification codes for the PWM signals can be generated in firmware. For example, the Walsh-Hadamard method can be used to generate a required number of CDMA modification codes. The required number of CDMA modification codes corresponds to the number of different color light sources used within the lighting unit, the number of independently controlled arrays of light sources or other criteria as would be readily understood by a worker skilled in the art. The number and specific CDMA modification codes can be preconfigured or dynamically generated in embodiments of the present invention.

In another embodiment, rather than using orthogonal sequences such as generated by the Walsh-Hadamard method, it is possible to use pseudorandom number (PRN) sequences (including Barker sequences, Katsumi sequences, Gold sequences, Golay sequences, and M-sequences) that have low autocorrelation properties. CDMA modification signals corresponding to these sequences do not require synchronization between CDMA modification signal generators and electronic CDMA filters, and so the technique can be referred to as asynchronous CDMA.

### Generation of CDMA Modification Signals

Orthogonal CDMA modification signals are generated from orthogonal CDMA modification codes by mapping each symbol in the symbol sequence comprising the code to a prespecified waveform.

In some embodiments, the CDMA modification signal comprises a switched waveform, having a piecewise constant electrical signal with its value updated at predetermined time increments. For example, the CDMA modification signal corresponding to the 4-symbol Walsh-Hadamard sequence (1,−1,1,−1) might comprise a switched electrical signal having length of four time periods, each of predetermined length, with the value of the electrical signal switching between two prespecified values substantially at the boundaries between each time period. In a further embodiment, the CDMA modification signal may comprise a switched waveform which switches between a substantially zero value and a predetermined positive value at predetermined time intervals, wherein the predetermined positive value is substantially equal to the peak value of another control signal associated with driving the light source, for example a PWM or PCM signal.

In other embodiments, the CDMA modification signal comprises a phase-shift keyed waveform, having a periodic signal whose phase is determined at predetermined time increments by successive values in the CDMA modification code. For example, the CDMA modification signal can be a modulated periodic square wave, rectangular wave, PWM or PCM waveform, or sine wave having a first period. At regular time intervals, typically intervals larger than the first period, the CDMA modification code is used to determine whether the phase of the periodic waveform should remain unchanged or whether the phase should be shifted, for example by 90 degrees. For example, the 4-symbol Walsh-Hadamard sequence (1,−1,1,−1) might result in phase shifts being applied during second and fourth time intervals. A worker skilled in the art would understand details of implementing a phase-shift keyed system, including variations such as quadrature or M-ary phase shift keying, differential phase-shift keying, and the like.

The length of each time period comprising the CDMA modification signal may vary in a prespecified or random manner. For this purpose, a linear congruential generator implemented as a shift register with feedback can be used to generate a pseudorandom timing sequence. An advantage of temporally varying the time periods comprising the CDMA modification signal is that interference due to noise, ambient light, or other CDMA modification signals may be reduced.

In one embodiment, the prespecified waveforms may be specified and changed at any time by the controller. For example, variation of the prespecified or random time periods of a waveform may be influenced by the controller. As another example, the values achieved by a switched waveform may be influenced by the control system.

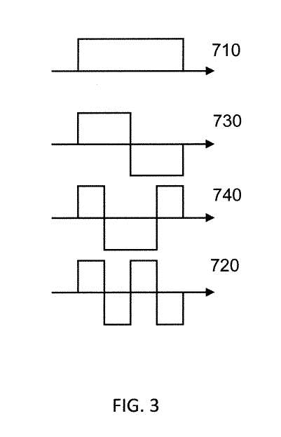

FIG. 3 illustrates an example of four CDMA modification signals generated using the Walsh-Hadamard matrix H(4) according to one embodiment of the present invention. Each symbol 1 or −1 in H(4) is mapped to a high or low constant value, respectively for a predetermined time interval.

For example, column 1 of matrix H(4) is represented as waveform 710, column 2 as waveform 720, column 3 as waveform 730, and column 4 as waveform 740. The waveforms illustrated in FIG. 3 may also be scaled by or added to any constant value, for example so that the lower value of the CDMA modification signal is substantially equal to the “OFF” value of an associated PWM or PCM signal, and the higher value of the CDMA modification signal is substantially equal to the “ON” value of the same PWM or PCM signal.

In one embodiment, the switched waveform CDMA modification signals have switching points being substantially synchronized between light sources. This type of waveform is consistent with synchronous CDMA as would be readily understood by a worker skilled in the art. For example, CDMA modification signals generated from orthogonal CDMA modification codes, such as are generated by the Walsh-Hadamard method, may be synchronized in this manner. In another embodiment, the CDMA modification signals are not substantially synchronized. For example, CDMA modification codes generated according to asynchronous CDMA can be applied to generate CDMA modification signals which are not substantially synchronized between light sources. This type of code may be desirable for example if the various CDMA modification signal generators and electronic CDMA filters are located within substantially separate units, for example if multiple lighting fixtures are positioned as in FIG. 2, such that the CDMA modification signal from a first lighting fixture is detected by optical sensors in a second lighting fixture, or when an optical sensor must otherwise measure the light output from multiple LED clusters. In embodiments of the present invention, an electronic CDMA filter can be configured to automatically synchronize to a predetermined CDMA modification signal.

### Encoding Information in CDMA Modification Signals

In embodiments of the present invention, each CDMA modification signal can serve as a unique identifier for the one or more light sources with which it is associated. Furthermore, the amplitude of a CDMA modification signal may be proportional to the amplitude of an associated PWM, PCM, or amplitude modulated signal controlling intensity of light. Independently of amplitude adjustments, a CDMA modification signal may further be used to transmit information through encoding of binary data, as is known in the art. An advantage of transmitting information using CDMA is that several transmissions can take place simultaneously.

In one embodiment, the CDMA modification signal may be a signal that switches between two or more values at prespecified or random time intervals. For example, the lowest value of the switched CDMA modification signal may be substantially equal to the “OFF” value of an associated PWM or PCM signal controlling intensity of light, or a zero value, and the highest value of the CDMA modification signal may be substantially equal to the “ON value of the same PWM or PCM signal, or a value of an amplitude modulated signal controlling intensity of light.

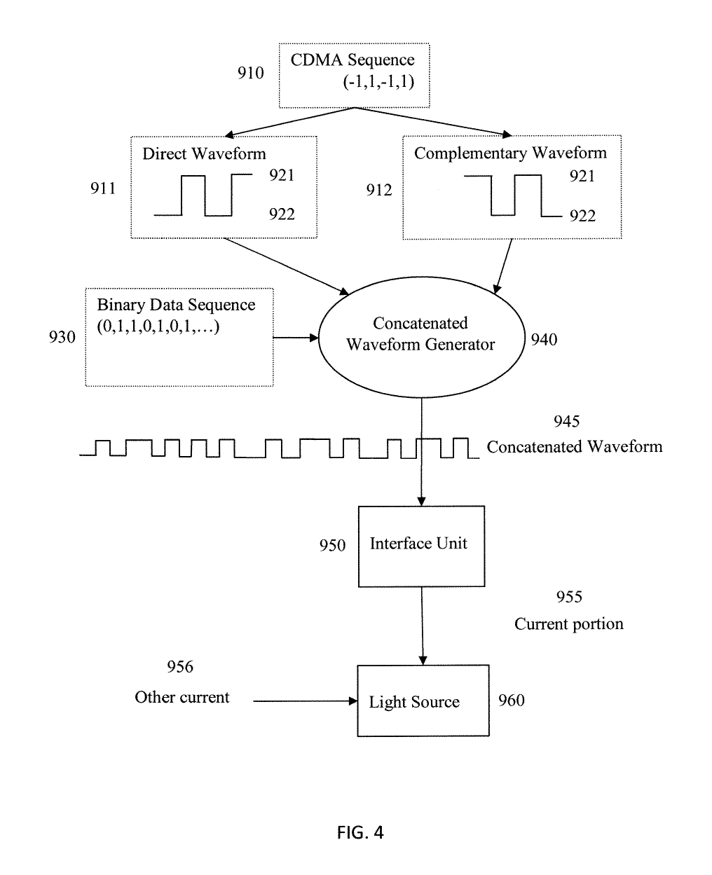

An advantage of encoding information about the intensity of light as a sequence of values or waveforms is that the encoded information can be substantially insensitive to variations in amplitude, and can be robust to ambient noise or interference. FIG. 4 illustrates a method for generation of a CDMA modification signal from a code sequence according to one embodiment of the present invention. A CDMA code sequence 910 is mapped to two time-varying waveforms, a direct waveform 911 and a complementary waveform 912. As an example of the direct waveform 911, symbol −1 followed by symbol 1 may result in a waveform which has a first value 921 for one time unit, followed by a second value 922 for one time unit. The complementary waveform 912 reverses the mapping of symbols to values; in the example above symbol −1 followed by symbol 1 may result in a waveform which has the second value 922 for one time unit, followed by the first value 921 for one time unit. Alternatively, the complementary waveform can be created by inverting the direct waveform. Waveforms 911 and 912 are operatively coupled to a concatenated waveform generator 940, which combines copies of waveforms 911 and 912 in sequence to generate a concatenated waveform 945. Additionally, a binary sequence 930 representing data to be transmitted may be operatively coupled to generator 940 to modulate the concatenated waveform 945. For example, a binary data symbol “zero” may result in selection of the direct waveform 911, and a binary data symbol “one” may correspond to selection of the complementary waveform 912. Sequential selection of waveforms 911 and 912 according to binary sequence 930 results in concatenated waveform 945. Alternatively, if no binary data is to be sent, an implementation equivalent to providing an arbitrary binary sequence 930, such as a sequence of all binary “zeros,” may be used. Concatenated waveform 945 is provided as input to an interface unit 950, which selectively applies the waveform or a modified version thereof as a portion 955 of the current supplying a light source 960. This portion 955 of current varies in time proportionally to the concatenated waveform. Other sources of current 956 may also be present, for example simultaneously or interleaved with current portion 955. It will be readily understood by a worker skilled in the art that alternative methods, essentially equivalent to the method above may be used to generate a CDMA modification signal.

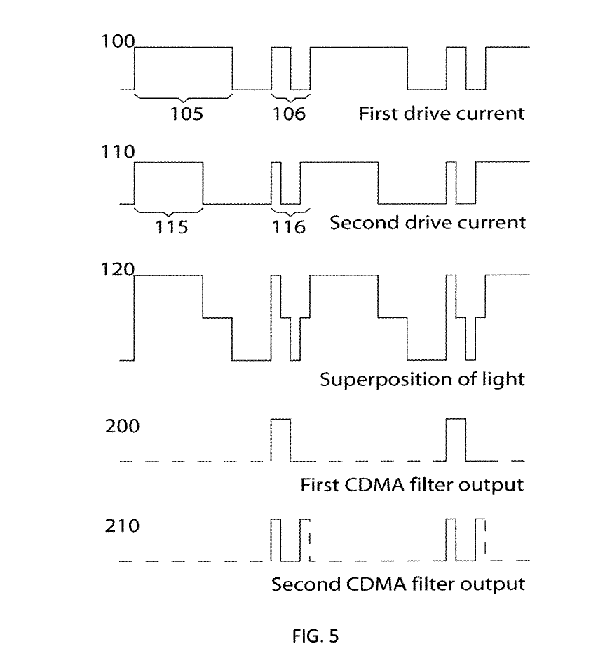

In one embodiment, as illustrated in FIG. 5, the CDMA modification signal may be used to convey information even without the binary encoding discussed above. FIG. 5 illustrates signal diagrams with examples of PWM drive current signals interleaved with orthogonal CDMA modification signals for two light sources, and the CDMA modification signal portions recovered from a superposition of signals. An interleaved signal 100 comprising a PWM modulated drive signal 105 and a CDMA modification signal 106 corresponding to a first array of one or more light sources and an interleaved signal 110 comprising a PWM modulated drive signal 115 and a CDMA modification signal 116 for a second array of one or more light sources are illustrated according to an embodiment of the present invention. FIG. 5 further illustrates a superposition 120 of signals 100 and 110, and examples of CDMA filter outputs, 200 and 210 corresponding with light from the first array of one or more light sources and light from the second array or one or more light sources, respectively, wherein the CDMA filter outputs are synchronized to output a signal during reception of light due to the interleaved CDMA modification signals. CDMA filter outputs 200 and 210 are obtained by using a CDMA decoding algorithm, such as by correlating the sampled sensor output or sensor signal with an appropriate CDMA modification code. Information is conveyed by comparing the amplitude of CDMA filter outputs 200 and 210 with the amplitude of the current drive signals 100 and 110. If signals 200 and 210 are in known proportion to the intensities of light of the corresponding light sources, the proportion of intensities of light to drive currents can thereby be determined.

### Application of CDMA Modification Signals to Light Sources

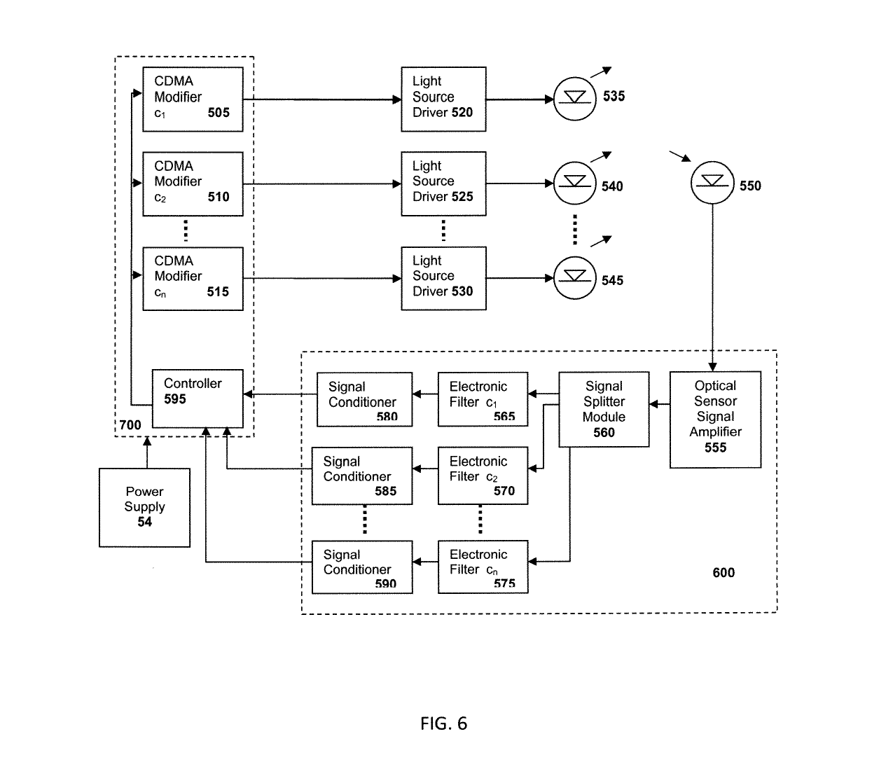

In one embodiment of the present invention, the control signals for activation of the light sources are independently controlled by PWM signals which contain or are interleaved with different CDMA modification signals for different color light sources and optionally for different lighting units of an illumination system. For example according to one embodiment of the present invention, the PWM signals and CDMA modification signal can be modified or selected by a control system 700 as illustrated in FIG. 6. For example a CDMA modification signal c1 can be selected for the red light sources 535, a CDMA modification signal c2 can be selected for the green light sources 540 and a CDMA modification signal cn can be selected for the blue light sources 545.

For example, the control system 700 can generate different PWM control signals with different PWM control signals for each group or array of one or more light emitting elements each being interleaved with independent CDMA modification signals associated with each group or array of one or more light sources. In particular the desired different PWM control signals are provided to CDMA modifiers 505, 510 and 515 which in return provide signals to the light source drivers 520, 525 and 530 for activation of the light sources 535, 540 and 545.

In one embodiment, the CDMA modification signal can be interleaved with the PWM, PCM, or pseudorandom PCM modulation drive current signal in any order within each PCM cycle as with PCM. Alternatively, the CDMA modification signal can be superimposed on the PWM, PCM, pseudorandom PCM or AM modulation drive current signal at all times or during prespecified time intervals. In one embodiment, the CDMA modification signal may be interleaved with the drive current according to a predetermined or random sequence.

For PWM, PCM, and pseudorandom PCM modulation, the transmission of the CDMA modification signal can also be distributed over multiple cycles. In addition to lowering the computational burden on the LED drive controller, this also enables the use of longer CDMA modification signals, or CDMA modification signals generated by longer CDMA modification codes, to support more LED channels.

### Electronic CDMA Filtering of Optical Sensor Signal

In one embodiment, accurately evaluating the radiant flux contributions from differently modulated light sources based on a single sensor signal obtained from a single broadband optical sensor sensing the mixed light can be achieved by processing the sensor signal using a CDMA decoding algorithm. For each differently modulated light source(s) for which the radiant flux contribution is to be evaluated, an appropriate CDMA symbol vector or modulation code is used in processing the optical sensor signal to recover the radiant flux contribution of that light source(s). For an optical sensor with sufficient linear responsivity across the range of operating conditions, the sensor output signal can be directly proportional to the input signal comprising light from the light sources. If, for practical purposes, the responsivity of the sensor is not sufficiently linear but still unambiguously correlates the output and the input signal, the correlation can be linearized, which, for example, can be performed by a signal processing system or controller.

In one embodiment, the CDMA filters can be implemented digitally in firmware. In one embodiment, the CDMA modification signals superimposed on the drive currents of different light sources result in modulation of the radiant flux of mixed light measured by the optical sensor. The radiant flux and the output of the optical sensor are modulated in part as a superposition of the CDMA modification signals of the different light sources. Digital filtering of the modulated signal comprises representing the sensor output as a sequence or vector, for example by sampling, where each component of the vector is proportional to the magnitude, phase or other aspect of the sensor output or to the radiant flux of the mixed light over a predetermined time interval, updated at time increments substantially synchronized with the predetermined time increments of the CDMA modification signal. The vector representing the sensor output is vector or inner product multiplied or otherwise correlated with the CDMA modification code, for example the Walsh-Hadamard sequence, used to generate the CDMA modification signal of the light source to which the electronic CDMA filter corresponds. Digital and analog circuits capable of converting the sensor signal into a vector and performing the required inner product operations are widely available, and readily understood by a worker skilled in the art.

Properly configured electronic CDMA filters with sufficiently high sampling rates can quickly and effectively eliminate crosstalk between light from different color light sources. This can improve the responsiveness of the optical feedback loop.

In one embodiment of the present invention, an electronic CDMA filter can be used to detect a desired CDMA modification signal by sampling the output of the one or more optical sensors at the expected times of reception of a desired CDMA modification signal. For example, this configuration can be useful when the time intervals of the CDMA modification signal vary.

In some embodiments, each COMA modification signal used in configuration of the control signal for a corresponding array of one or more light sources is also provided to a corresponding electronic CDMA filter. The CDMA filter discriminates the radiant flux of the corresponding array of one or more light sources from the sample of the mixed radiant flux output collected by, for example one or more broadband optical sensors. The code can be provided directly or by providing a look-up or index value for the CDMA filter.

In one embodiment and with further reference to FIG. 6, the output of the optical sensor 550 is coupled to a signal processing system 600 which comprises an optical sensor signal amplifier 555, wherein this signal is subsequently split by a signal splitter module 560 for transmission to the inputs of electronic CDMA filters 565, 570 and 575. For example, these electronic CDMA filters can be configured to allow signals corresponding to one or more desired CDMA modification codes to pass while rejecting all others as would be readily understood by a worker skilled in the art. The electronic CDMA filters 565, 570 and 575 are configured to correspond to the CDMA modification codes of the PWM signals used for modification of the light source drive currents. For example, if the drive currents for the red light sources 535, green light sources 540, and blue light sources 545 are modified with PWM signals having CDMA modification codes x, y, and z, respectively, the electronic CDMA filters 565, 570 and 575 are chosen to correspond to the CDMA modification codes x, y, and z, respectively. The CDMA modification codes x, y, and z may be associated with information about the radiant flux outputs of the red light sources 535, green light sources 540 and blue light sources 545, respectively. Accordingly, the resultant signals at the outputs of the individual electronic CDMA filters 565, 570 and 575 will be directly proportional to the radiant flux outputs of the red light sources 535, green light sources 540 and blue light sources 545, respectively.

The outputs of the electronic CDMA filters 565, 570 and 575 are coupled to the controller 595. Based on the values of the radiant flux output for each color of light source from the electronic CDMA filters 565, 570 and 575, the controller 595 can compensate for and adjust the amounts of drive current for the red light sources 535, green light sources 540, and blue light sources 545 in order to maintain the luminous flux and chromaticity of the output light at desired levels.

Still referring to FIG. 6, the outputs of the electronic CDMA filters 565, 570 and 575 can be operatively coupled to separate signal conditioners 580, 585 and 590, prior to the transmission of the collected information to the controller 595 of the control system 700.

### Processing Electronic CDMA Filter Data

Information encoded in the CDMA modification signal to which an electronic CDMA filter is tuned may be recovered by processing data from the electronic CDMA filter. The recovered information can be used for feedback purposes. In one embodiment, binary data encoded in the CDMA modification signal is decoded by correlating the sampled sensor output or sensor signal with the CDMA modification code used to generate the CDMA modification signal, as would be known by a worker skilled in the art. Also, the inner product of the vector representing the sensor output and a vector representing one of the CDMA modification codes can be used to modulate one of the light sources returns a numerical value which can be processed to recover the intensity of the radiant flux of the light source modulated by said CDMA modification code. For example, if the CDMA modification code used to generate a CDMA modification signal for a selected light-emitting is a k-symbol Walsh-Hadamard sequence, and the same COMA modification code is provided to the electronic CDMA filter, then:

A_{S}=A_{R}/k (2)

where A_{S} is the amplitude of the CDMA modification signal corresponding to the selected light source as it appears in the radiant flux of that light source, and A_{R} is a value provided by the electronic CDMA filter. For example, A_{R} can be the amplitude of a numerical sequence obtained by vector or inner product multiplying the k-bit CDMA modification code by successive length-k sequences of values sampled from the optical sensor.

Although equation (2) may not necessarily or exactly apply to arbitrary pseudorandom number (PRN) sequences, it is possible to recover transmitted signal amplitudes by various signal processing methods as would be known by a worker skilled in the art. Although there may be a possibility of some small amount of crosstalk between LED channels that is a function of the chosen sequence autocorrelation properties, it is still possible to establish a useful and robust correlation between the transmitted and decoded signal amplitudes.

In another embodiment of the present invention, the output of each CDMA filter may be sampled with a peak detector amplifier to determine the instantaneous radiant flux output for the associated color. The output of each CDMA filter may also be subjected to further low-pass filtering by way of low pass filters to determine the time-averaged radiant flux output for each color, or by way of predictive filters such as Kalman filters to predict short-term changes in the radiant flux of the emitted light.

As an illustrative example, consider two light sources A and B, having two-bit orthogonal CDMA modification codes CA=(1,−1) and CB=(1,1), respectively. Element A may be configured to transmit arbitrary binary data, for example binary data (1,0,1,1). Element B may be likewise configured to transmit arbitrary binary for example, binary data (0,0,1,1). For element A, generation of the CDMA modification signal may comprise encoding each bit of binary data as CA if the bit is 1, and −CA if the bit is 0. This would result in symbol sequence (1,−1,−1,1,1,−1,1,−1) corresponding to the data for element A. For element B, generation of the CDMA modification signal may comprise encoding each bit of binary data as CB if the bit is 1, and −CB if the bit is 0. This would result in symbol sequence (−1,−1,−1,−1,1,1,1,1) corresponding to the data for element B. Each symbol sequence may be mapped to a CDMA modification signal to be transmitted by the light source. For example, the mapping may comprise providing a first current amplitude for a prespecified time period in the corresponding light source A or B in response to symbol element 1, and providing a second current amplitude for a prespecified time period in the corresponding light source A or B in response to symbol element −1. For example, the first current amplitude may be IA units of current for light source A, and IB units of current for light source B, whereas the second current amplitude may be zero for both light sources. These values may be substantially the same as those of a PWM signal with which the CDMA modification signals are interleaved.

Continuing with the above example, synchronous transmission of the CDMA modification signals via light sources A and B may result in a mixed light of periodically varying intensity sensed by the one or more optical sensors and output as an electrical signal. Electronic CDMA filters A and B, to receive CDMA modification signals from light sources A and B, respectively, may sample the output of the one or more optical sensors, converting the samples to a sequence of analog or digital values. For example, symbol element 1 at light source A may correspond to a contribution of 3 units of sampled value at each electronic CDMA filter, while symbol element −1 at light source A may correspond to a contribution of 1 unit. Symbol element 1 at light source B may correspond to a contribution of 5 units of sampled value at each electronic CDMA filter, while symbol element −1 at light source B may correspond to a contribution of 2 units. These values are for illustrative purposes only and may alternatively be other real values, representing units of output from the one or more optical sensors. In this example, each electronic CDMA filter will see a sequence of sample values (5,3,3,5,8,6,8,6) corresponding to the additive contribution of sampled values of light sources A and B. If ambient light is present, sensing of ambient light may correspond to a constant value being added to this sequence of sample values. To decode the sample values at each electronic COMA filter, each pair of sequential sample values can be vector or inner product multiplied by modulation codes CA and CB. For example, electronic CDMA filter A may vector multiply (1,−1) by (5,3), (3,5), (8,6) and (8,6) to obtain sequence (2,−2,2,2), while electronic CDMA filter B may vector multiply (1,1) by (5,3), (3,5), (8,6) and (8,6) to obtain sequence (8,8,14,14). By mapping high values in the obtained sequences to “1” bits, and low values to “0” bits, the original binary data can be recovered. This method is substantially insensitive to ambient light that results in a constant or slowly varying value being added to the sample values.

In one embodiment of the present invention, an amplitude determination method, such as that corresponding to equation (2), may be applied simultaneously to determine the amplitude of each CDMA modification signal. This method may be applied independently of other information encoded into the COMA modification signal as a sequence of values or waveforms. To illustrate, in relation to the above example light from light source A resulted in maximum and minimum contributions of 3 units and 1 unit of sampled value at each electronic COMA filter, thereby comprising a switched waveform having a peak-to-peak amplitude of AS=2 units. Also in the above example, light from light source B resulted in maximum and minimum contributions of 5 units and 2 units of sampled value at each electronic CDMA filter, thereby comprising a switched waveform having a peak-to-peak amplitude of AS=3 units. Due to mixture of light, it may not be possible to discriminate these amplitude values before CDMA filtering. However, the amplitude values can be derived from the output sequences of each electronic CDMA filter. For example, the peak-to-peak amplitude AR of electronic CDMA filter A output sequence (2,−2,2,2) is AR=4; applying equation (2) yields the correct amplitude value of AS=4/2=2. Similarly, the peak-to-peak amplitude AR of electronic CDMA filter B output sequence (8,8,14,14) is AR=6; applying equation (2) yields the correct amplitude value of AS=6/2=3.

The preceding example used peak-to-peak amplitude as its amplitude metric, however the method itself can be more universal. Similar results can hold if other amplitude metrics are used, such as peak amplitude, RMS (root mean squared) amplitude, or mean amplitude, provided that the same amplitude metric is applied to both AS and AR of equation (2).

In one embodiment, the amplitude determination method corresponding to equation (2) can be used to determine the conversion efficiency, of electrical current into light, of the light sources. Given determined amplitude AS of light corresponding to a selected light source, the current supplied to the same light source for generation of the associated light, and any required conversion factor or function required to translate units of light emitted by the light source and units of sampled value introduced at the input to the one or more optical sensors, the conversion efficiency of the light source can be computed. Current sensors may be supplied for this purpose, for example as illustrated in FIG. 1. In addition, a predetermined conversion factor or function between units of light emitted by the light source and units of sampled value introduced at the input to the one or more optical sensors can be supplied or periodically calibrated.

In another embodiment, an amplitude determination method such as described above can be used to determine the conversion efficiency between current supplied to each light source and units of sampled value introduced at the input to the one or more optical sensors, or the conversion efficiency between current supplied to each light source and an amount of light falling on the one or more optical sensors.

In one embodiment, determination of a conversion efficiency may be based on assumption of one or more linear or nonlinear transfer functions describing aspects such as conversion of electrical current into emitted light, conversion of emitted light into sensed light, or conversion of sensed light into sampled values at an electronic CDMA filter.

More generally, and in relation to the above example, the CDMA modification signal emitted by light source A may comprise a switched waveform WA such that symbol element 1 at light source A may correspond to a contribution of a units of sampled value at each electronic CDMA filter, while symbol element −1 at light source A may correspond to a contribution of −a units. The CDMA modification signal emitted by light source B may comprise a switched waveform WB such that symbol element 1 at light source B may correspond to a contribution of b units of sampled value at each electronic CDMA filter, while symbol element −1 at light source B may correspond to a contribution of −b units. Each CDMA modification signal may also comprise a constant-valued waveform, such that the contributions of sampled value are positive. The two switched waveforms WA and WB will contribute to the sequence of sampled values at each electronic CDMA filter, the contribution being substantially (a−b,−a−b,−a−b,a−b,a+b,−a+b,a+b,−a+b). Other constant values may be added to this sequence to constitute the overall sequence of sampled values at each electronic CDMA filter; however such values will be filtered out by the subsequent code or amplitude determination methods. Decoding of the sequence of sampled values by pairwise vector multiplication with CDMA modification code (1,−1) for electronic CDMA filter A and with CDMA modification code (1,1) for electronic CDMA filter B will yield recovered data sequences (2a,−2a,2a,2a) and (−2b,−2b,2b,2b), respectively. The encoded data (1,0,1,1) and (0,0,1,1) can be recovered from these recovered data sequences by mapping positive values to logical value 1 and negative values to logical value 0. Amplitude determination can be carried out using equation (2), which will yield for example peak-to-peak amplitudes 2a and 2b for light sources A and B, respectively.

In one embodiment, the amplitude determination method may be used to adjust current supplied to each light source, for example in order to achieve a desired chromaticity or luminous flux output of both.

### Interference Rejection Properties of CDMA Modification Signals

Due to the use of non-orthogonal codes or the presence of electrical or optical interference, such as electrical noise in the current drivers driving the light sources, optical noise due to ambient light, or optical noise due to other light sources, filtering and decoding of the CDMA modification signal by the electronic CDMA filters may result in erroneous measurements. Such noise or interference may be reduced by varying the temporal parameters of the CDMA modification signals, such as the transmission times and duration of transmission of each portion of the CDMA modification signals. Noise or interference may also be reduced by selecting CDMA modification codes which have low cross-correlation with other selected codes, or by selecting COMA modification codes with longer symbol sequences. Therefore, embodiments of the present invention can be configured based upon these principles.

In one embodiment, interference due to the presence of constant or slowly varying ambient light can be reduced by using CDMA modification codes with zero mean. For example, a property of many Walsh-Hadamard sequences is that each sequence averages to zero over the time of one cycle. Constant ambient illumination can therefore be disregarded simply by removing the DC component from the received signal prior to decoding.

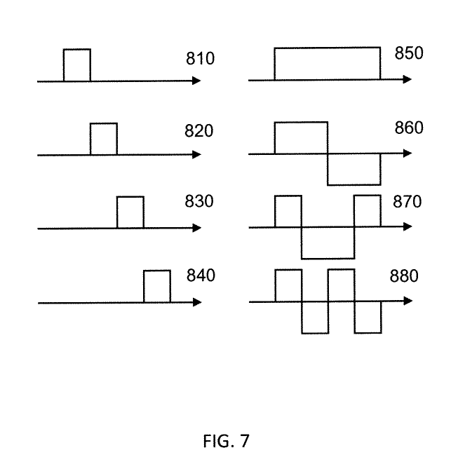

In one embodiment, data encoded in the COMA modification signal can be robust to electrical or optical noise or interference. For example, a property of COMA modification codes generated according to the Walsh-Hadamard method is that the signal-to-noise ratio for each COMA modification is improved by a factor of \sqrt{k/2}, where k is the symbol length of the generating Walsh-Hadamard sequence, in comparison to the method of transmitting each data stream using time division multiplexing. For example, this property is illustrated with reference to FIG. 7. The left-hand waveforms 810, 820, 830, and 840 illustrate a data transmission method using time division multiplexing. In this method, each of four light sources transmit a waveform encoding one bit of information, wherein the information containing parts of each waveform do not overlap in time. The probability of correctly receiving one bit in the presence of noise is given by a value P. The right-hand waveforms 850, 860, 870, and 880 illustrate analogous waveforms according to synchronous code division multiplexing, where each waveform now encodes at least two bits of data, and the information containing parts of each waveform overlap in time. This concurrent information transmission and spreading of information over time can improve signal robustness. For example, if the probability of correctly receiving one bit in the presence of noise is P, the probability of correctly receiving k copies of the bit is P*\sqrt{k/2}. Hence, the signal-to-noise ratio is improved by a factor of \sqrt{k/2}. For a four-channel RAGB LED cluster with four orthogonal sequences, for example, the interference rejection is better by a factor of \sqrt{2}.

For example, noise in the present context refers to both random electrical noise and deterministic signals due to for example optical signals generated by fluorescent lighting and other light sources.

In one embodiment, the interference rejection can be further improved by randomly varying the temporal spacing between the orthogonal sequence bits of the CDMA modification codes within each PCM cycle. For this purpose, a linear congruential generator implemented as a shift register with feedback can be used to generate a pseudorandom timing sequence.

In one embodiment, the interference rejection can be further improved by using longer orthogonal sequences of CDMA modification codes, distributed if necessary over multiple PCM cycles. The transmission of orthogonal sequences is an example of direct spread spectrum (DSS) communications; the interference rejection improvement is referred to as the “processing gain.”

### Feedback

The processed outputs of the CDMA filters are coupled to the controller. Based on the inferred radiant flux of each color of light sources from the CDMA filters, the controller can compensate for and adjust the amounts of drive current supplied to the red light sources, green light sources, and blue light sources in order to maintain the luminous flux and chromaticity of the emitted light at desired levels.

In another embodiment, the outputs of the CDMA filters can be operatively coupled to a proportional-integral-derivative (PID) feedback loop circuit that can be implemented in firmware in the controller. The PID feedback loop circuitry (not shown) can be a separate component operatively connected to the controller.

### Device Autoconfiguration

In one embodiment of the present invention, a lighting unit can perform a configuration operation. During the configuration operation the lighting unit can, for example, generate light and modulate a portion of that light according to one or more CDMA modification signals generated using one or more predetermined CDMA modification codes and subsequently process all sensed responses, for example CDMA filter outputs, tuned to the CDMA modification codes. If the control system detects sufficiently low response in the sensed signal other than that originating from the modulation of its own light, that is low interference, it can use these CDMA modification codes for subsequent generation of CDMA modulation signals for use with of its light sources. If it receives a response that does not sufficiently correlate with the CDMA modulation of its own light sources, the lighting unit can change the one or more CDMA modification codes at which it modulates its own light sources and can repeat the above operation until a sufficient number of sufficiently usable CDMA modification codes have been detected.

In another embodiment of the present invention, wherein an illumination system includes a plurality of lighting units, a lighting unit can scan for CDMA modification codes possibly in use in a predetermined sequence, accumulate an adequate number of usable CDMA modification codes and use these usable CDMA modification codes for subsequent generation of CDMA modulation signals for use with of its light sources.

In one embodiment of the present invention, the CDMA modification codes associated with a particular lighting unit can have a predetermined relationship that clearly identifies all other CDMA modification codes used by that lighting unit, for example when only one CDMA modification code is known.

It is noted that while two or more lighting units can communicate with each other, each of them can be separately supplied with electrical energy. If the optical sensor of one lighting unit receives enough light from any other lighting unit, that lighting unit can also detect the CDMA modification codes of the other lighting unit and reconfigure itself as described above.

In another embodiment, lighting units in an illumination system are connected together for control purposes, and signals can be passed between the lighting units to communicate information about the CDMA modification codes being used. The physical connection can be wired, wireless, optical or acoustic etc and can be used to support other known suitable communication protocols including TCP/IP and RS-232, for example.

In one embodiment of the present invention, the control system is adapted to selectively turn OFF a selected array and monitor the output signals from the electronic CDMA filters to process the light emitted from the arrays that remain energized in order to assign a unique CDMA modification code to the selected array and the respective electronic CDMA filters.

Embodiments of the present invention can be configured to continuously, frequently or intermittently evaluate CDMA modification codes during a self-configuration procedure in order to avoid sharing the same or similar CDMA modification codes with other nearby potentially interfering lighting units. For this purpose the control system of the lighting unit can be configured to include switching the lighting unit into a passive scan mode while sensing and scanning for a sufficient number of free available CDMA modification codes. The control system can configure the lighting unit to enter the scan mode for a brief period of time, for example, during a switch ON of the lighting unit or during an OFF period. The control system can scan a predetermined range of CDMA modification codes in the sensed light according to a predetermined scheme until a sufficient number of free CDMA modification codes or groups of CDMA modification codes have been determined. The control system can subsequently retain the available CDMA modification codes in a memory within the lighting unit. The controller can subsequently assign a free CDMA modification code to each light source color, and use these CDMA modification codes to generate CDMA modification signals for modulation of the respective light source drive currents.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

What is claimed is:

1. A lighting unit (10) for generating light having a desired luminous flux and/or chromaticity, the lighting unit comprising:
a. one or more first arrays (20) of one or more light sources adapted to generate first light in response to a first drive current and one or more second arrays (30) of one or more light sources adapted to generate second light in response to a second drive current;
b. a first current driver (28) configured to supply the first drive current to the one or more first arrays based on a first control signal, and a second current driver (38) configured to supply the second drive current to the one or more second arrays based on a second control signal;
c. an optical sensor (60) for sensing a portion of the light comprising a combination of the first light and second light, the optical sensor configured to generate a sensor signal representative of the light;
d. a controller (50) configured to generate the first control signal and second control signal based at least in part on the desired luminous flux and/or chromaticity, the first control signal configured at least in part according to a first CDMA modification signal, thereby resulting in the first light being modulated at least in part according to the first CDMA modification signal; and
e. an electronic CDMA filter (24) configured to electronically filter the sensor signal based on the first CDMA modification signal, thereby determining one or more optical characteristics of the first light for feedback to the controller;
thereby providing feedback to the controller to facilitate generating light having a desired luminous flux and/or chromaticity.

2. The lighting unit according to claim 1, wherein the first light is CDMA encoded according the first CDMA modification signal at time intervals or continuously.

3. The lighting unit according to claim 1, wherein the first CDMA modification signal is configured according to a CDMA modification code selected from the group comprising: pseudorandom codes, Walsh-Hadamard codes, Barker codes, Katsumi codes, Gold codes, Golay codes, and M-codes.

4. The lighting unit according to claim 1, wherein the first CDMA modification signal is represented in the first light as a piecewise constant switched waveform varying between two or more light levels in accordance with the first CDMA modification signal.

5. The lighting unit according to claim 1, wherein the first CDMA modification signal is represented in the first light as a phase shift keyed waveform having a phase varying in accordance with the first CDMA modification signal.

6. The lighting unit according to claim 1, wherein the electronic CDMA filter is configured to correlate the sensor signal with the first CDMA modification signal.

7. The lighting unit according to claim 1, wherein the one or more optical characteristics of the first light are processed with a measurement of the first drive current to determine light conversion efficiency of the first array of one or more light sources.

8. The lighting unit according to claim 1, wherein the second control signal is configured at least in part according to a second CDMA modification signal, the lighting unit further comprising a second electronic CDMA filter configured to electronically filter the sensor signal based on the second CDMA modification signal, thereby determining one or more optical characteristics of the second light for feedback to the controller.

9. The lighting unit according to claim 1, further comprising an autoconfiguration module for determining the first CDMA modification signal, the autoconfiguration module configured to generate the first control signal according to the first CDMA modification signal and measure interference to the first CDMA modification signal at the electronic CDMA filter.

10. The lighting unit according to claim 1, wherein the first CDMA modification signal is configured to be different from one or more CDMA modification signals being used in a second lighting unit.

11. A method for generating light having a desired luminous flux and/or chromaticity, the light comprising first light from a first light source and second light from a second light source, the method comprising the steps of:
a. generating a first drive current and a second drive current, each based at least in part on the desired luminous flux and/or chromaticity, the first drive current further configured at least in part according to a first CDMA modification signal;
b. driving the first light source and the second light source according to the first drive current and the second drive current, respectively, thereby resulting in the first light being modulated at least in part according to the first CDMA modification signal;
c. generating a sensor signal representative of the light; and
d. filtering the sensor signal based on the first CDMA modification signal, thereby determining one or more optical characteristics of the first light for feedback when generating a new first drive current and a new second drive current.

12. The method according to claim 11, wherein driving the first light source comprises modulating the first light according the first CDMA modification signal at time intervals or continuously.

13. The method according to claim 11, wherein the first CDMA modification signal is configured according to a CDMA modification code selected from the group comprising: pseudorandom codes, Walsh-Hadamard codes, Barker codes, Katsumi codes, Gold codes, Golay codes, and M-codes.

14. The method according to claim 11, wherein the first light comprises a piecewise constant switched waveform varying between two or more light levels in accordance with the first CDMA modification signal.

15. The method according to claim 11, wherein the first light comprises a phase shift keyed waveform having a phase varying in accordance with the first CDMA modification signal.

16. The method according to claim 11, wherein filtering the sensor signal comprises correlating the sensor signal with the first CDMA modification signal.

17. The method according to claim 11, further comprising the step of processing the one or more optical characteristics of the first light with a measurement of the first drive current to determine light conversion efficiency of the first light source.

18. The method according to claim 11, wherein the second drive current is configured at least in part according to a second CDMA modification signal, thereby resulting in the second light being modulated at least in part according to the second CDMA modification signal, and further comprising filtering the sensor signal based on the second CDMA modification signal, thereby determining one or more optical characteristics of the second light for feedback when generating the new first drive current and the new second drive current.

19. A computer program product comprising a computer readable medium having recorded thereon statements and instructions for execution by a processor to carry out a method for generating light having a desired luminous flux and/or chromaticity, the light comprising first light from a first light source and second light a second light source, the method comprising the steps of:
a. generating a first drive current and a second drive current, each based at least in part on the desired luminous flux and/or chromaticity, the first drive current further configured at least in part according to a first CDMA modification signal;
b. driving the first light source and the second light source according to the first drive current and the second drive current, respectively, thereby resulting in the first light being modulated at least in part according to the first CDMA modification signal;
c. generating a sensor signal representative of the light; and
d. filtering the sensor signal based on the first CDMA modification signal, thereby determining one or more optical characteristics of the first light for feedback when generating a new first drive current and a new second drive current.
